(19) United States
(12) Patent Application Publication
(10) Pub. No.: US 2014/0210409 A1
(43) Pub. Date: Jul. 31, 2014

(54) METHOD FOR CONTROLLING SWITCHES OF A CURRENT RECTIFIER CONNECTED TO AN ON-BOARD CHARGER

(71) Applicants: Christophe Ripoll, Chevreuse (FR); Noelle Janiaud, Massy (FR); Olivier Reyss, Montrouge (FR)

(72) Inventors: Christophe Ripoll, Chevreuse (FR); Noelle Janiaud, Massy (FR); Olivier Reyss, Montrouge (FR)

(73) Assignee: RENAULT s.a.s., Boulogne-Billancourt (FR)

(21) Appl. No.: 14/119,735

(22) PCT Filed: May 15, 2012
(86) PCT No.: PCT/FR2012/051086

§ 371 Date: Feb. 28, 2014

Related U.S. Application Data
(60) Provisional application No. 61/524,014, filed on Aug. 16, 2011.

(30) Foreign Application Priority Data
May 23, 2011 (FR) 1154467

(51) Int. Cl. B60L 11/18

(52) U.S. Cl. CPC B60L 11/1812
USPC 320/109

(57) ABSTRACT

A method for controlling switches of a current rectifier installed on a motor vehicle, including: determining a neutral point current intensity required at an output of the rectifier; determining current vector coordinates making it possible to obtain the neutral point current in a Fresnel space including six sectors defined by six remarkable vectors; determining a half-sector including the current vector among twelve half-sectors forming the Fresnel space; determining a weighted vectorial combination of two remarkable vectors defining the Fresnel sector making it possible to obtain the current vector; switching the current rectifier switches to obtain the current vector in accordance with the weighting coefficients; and obtaining a free-wheel vector for remaining time of a cutting period minimizing voltage differences between the ground and the voltage rectifier during transition from one switching to another.

The invention is in the technical domain of controlling current rectifiers and more specifically controlling current rectifiers in systems with no galvanic isolation.

The use of a three-phase, unisolated charger in an electric vehicle, when connected to the distribution network, results in a leakage current to ground that may cause disturbances on the network.

The absence of galvanic isolation in the charger, between the mains and the power conversion modules, causes a return of the leakage currents of the vehicle to ground. Each element, on account of the structure thereof, has a common-mode capacitance in relation to the chassis. A leakage current appears when an alternating voltage is applied to all of the common-mode capacitors.

This phenomenon is amplified by the switching applied to three-phase alternating power supplies in order to obtain continuous magnitudes. Indeed, significant negative high-voltage variations occur when switching the switches of the rectifier. These variations increase the leakage current as a result of the dependence on the temporal variation of the voltage applied to the terminals of the common-mode capacitors. Since these capacitors are placed between ground and the elements, they are subjected directly and in full to the negative high-voltage variations.

The solution to this problem found in the prior art involves placing filters between the power supply network and the rectifier, and dimensioning them appropriately.

However, such a solution has the drawback of being expensive.

One objective of the invention is to limit the leakage currents more affordably than in the prior art.

Another objective of the invention is to limit the high-frequency component of the leakage currents.

One aspect of the invention proposes a method for controlling the switches of a current rectifier in a motor vehicle fitted with an on-board charger that can be connected to a three-phase electricity distribution network. The method includes steps involving:
Determination of an intensity of a neutral-point current required at the output of the rectifier,
Determination of the coordinates of the current vector enabling said neutral-point current to be obtained in the Fresnel space comprising six sectors delimited by six remarkable vectors,
Determination of a half-sector comprising the current vector from twelve half-sectors forming the Fresnel space,
Determination of a weighted vector combination of the two remarkable vectors delimiting the Fresnel sector enabling the current vector to be obtained,
Determination of an opening/closing sequence of the switches of the current rectifier as a function of the weighting coefficients of the weighted vector combination of the remarkable vectors, and
Determination of an opening/closing sequence of the switches of the current rectifier to obtain a freewheeling vector for the remaining duration of the switching period minimizing the voltage deviations between ground and the voltage rectifier when switching from one opening/closing sequence of the switches of the current rectifier to another.

Conventional division of the Fresnel space means dividing a two-dimensional orthonormal space representing all of the complex currents or voltages into six sectors of equal area. In such a space, the norm of a vector corresponds to the intensity of the current or of the voltage, while the direction thereof indicates the phase thereof.

Such a method has the advantage of limiting the voltage deviations between the output of the rectifier and ground, which makes it possible to limit the leakage currents through the common-mode capacitors of the different elements of the electrical circuit of the vehicle. Limiting the voltage deviations results from an appropriate choice of a freewheeling vector as a function of the remarkable vectors defining the current vector. The freewheeling vector may depend on the half-sector in which the current vector is located.

It is possible to determine, for each opening/closing sequence of the switches of the current rectifier used to obtain a current vector, an opening/closing sequence of the switches of the current rectifier to obtain a freewheeling vector that has a minimum voltage deviation between ground and the voltage rectifier when switching from the opening/closing sequence of the switches of the current rectifier used to obtain the current vector to the one used to obtain the freewheeling vector.

It is possible to determine, for each opening/closing sequence of the switches of the current rectifier used to obtain a current vector, an opening/closing sequence of the switches of the current rectifier to obtain a freewheeling vector that has a voltage deviation between ground and the voltage rectifier when switching from the opening/closing sequence of the switches of the current rectifier used to obtain the current vector to the one used to obtain the freewheeling vector, said voltage deviation being at most equal to the voltage deviation between two phases.

It is possible to determine, for each opening/closing sequence of the switches of the current rectifier used to obtain a current vector, an opening/closing sequence of the switches of the current rectifier to obtain a first freewheeling vector if the half-sector including the current vector is one of four consecutive half-sectors, a second freewheeling vector if the half-sector including the current vector is one of four other consecutive half-sectors, and a third freewheeling vector if the half-sector including the current vector is one of the four remaining consecutive half-sectors.

The same opening/closing sequence of the switches of the current rectifier used to obtain a freewheeling vector can be determined regardless of the opening/closing sequence of the switches of the current rectifier used to obtain a current vector.

Other objectives, characteristics and advantages will become apparent on reading the description below, given purely by way of non-limiting example and in reference to the attached drawings, in which:

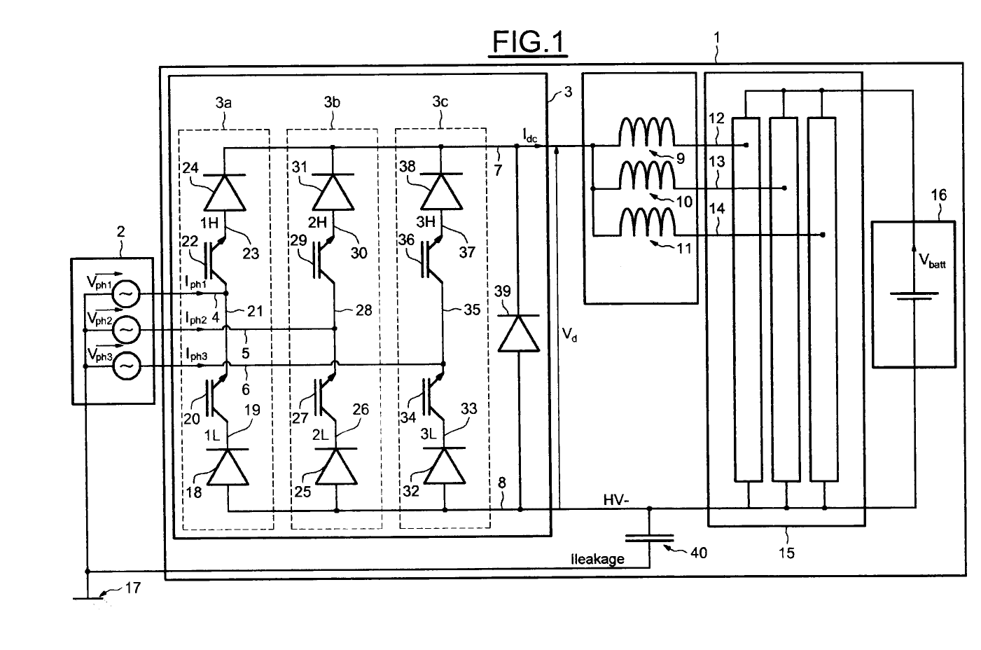

FIG. 1 shows the main elements of an electric vehicle connected to a three-phase network,

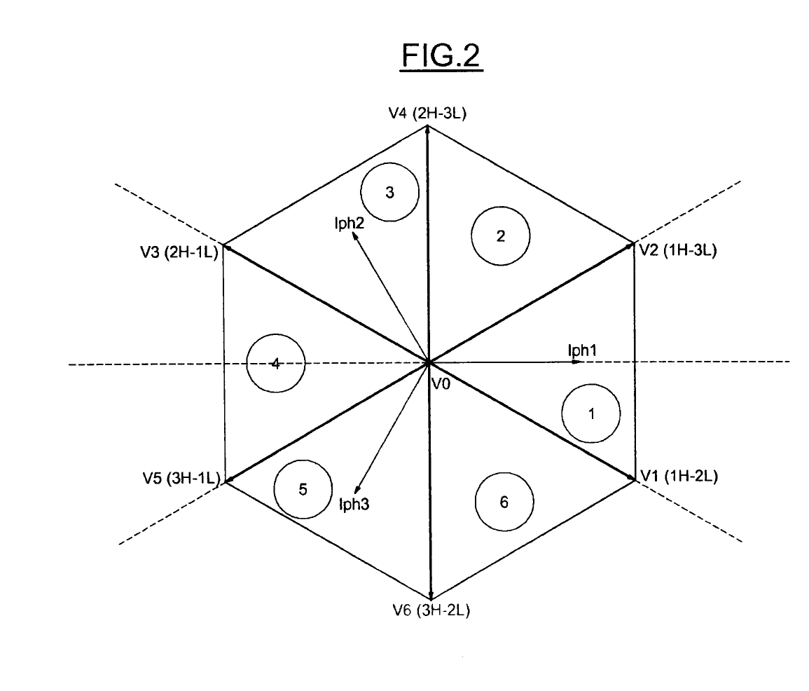

FIG. 2 shows a Fresnel diagram related to a three-phase rectifier according to the prior art, and

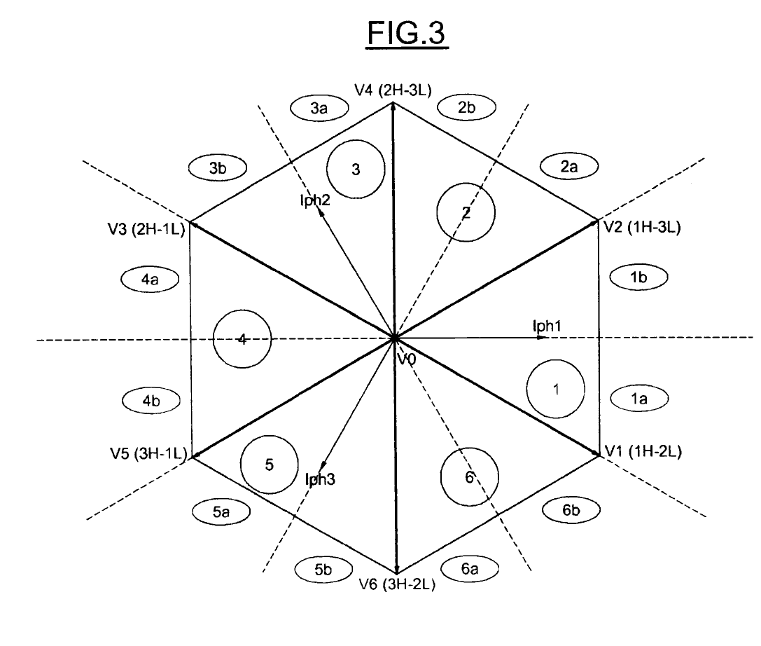

FIG. 3 shows a Fresnel diagram related to a three-phase rectifier according to the invention.

FIG. 1 shows the electrical network 1 of an electric vehicle connected to a three-phase distribution network 2.

The electrical network 1 includes the elements belonging to the powertrain and the elements specific to the charger. Thus, although part of materially distinct entities, these elements are connected together when the electric vehicle is connected to the charger.

The electrical network 1 includes a rectifier 3 connected to the three-phase network 2 by three connections 4, 5, 6 each carrying a current phase. The electrical network 1 is defined by two electrical magnitudes, the neutral-point current and the negative high voltage, both occurring at the output of the rectifier. The rectifier 3 has three phases 3a, 3b, 3c connected at the output to a connection 7 carrying a direct current and to a connection 8 carrying the negative high voltage. More specifically, each phase of the three-phase distribution network 2 is connected to the corresponding phase of the rectifier 3.

FIG. 1 also shows a detailed view of the structure of the rectifier 3. The three phases 3a, 3b, 3c are shown connected firstly to the connection 7 carrying the neutral-point current and secondly to the connection 8 carrying the negative high voltage.

Each phase 3a, 3b, 3c includes a first diode 18, 25, 32 connected by the anode to the connection 8, the cathode of which is connected to the collector of a first transistor 20, 27, 34 via a connection 19, 26, 33. The emitter of the first transistor 20, 27, 34 is connected to the collector of a second transistor 22, 29, 36 by a connection 21, 28, 35. The emitter of the second transistor 22, 29, 36 is connected to the anode of a second diode 24, 31, 38 by a connection 23, 30, 37. The cathode of the second diode 24, 31, 38 is connected to the connection 7.

A freewheeling diode 39 is connected by the cathode thereof to the cathodes of the second diodes 24, 31, 38 while the anode thereof is connected to the anodes of the first diodes 18, 25, 32.

The connection 7 is connected to the windings 9, 10, 11 of the electric traction unit. Each winding 9, 10, 11 is also connected to a connection 12, 13, 14 leading to one of the phases of an inverter 15. Each phase of the inverter 15 is connected to the connection 8 carrying the negative high voltage, as well as to the anode of a battery 16. The other extremity of each phase of the inverter 15 is connected to the cathode of the battery 16.

The connection 8 carrying the negative high voltage is also connected to ground 17, and to the three-phase distribution network 2.

The three-phase distribution network 2 supplies a voltage Vph1 and an intensity Iph1 on the first phase thereof, a voltage Vph2 and an intensity Iph2 on the second phase thereof and a voltage Vph3 and an intensity Iph3 on the third phase thereof.

Each phase of the rectifier enables generation of a component of a neutral-point direct current Idc emitted by the connection 7. The value of the current Idc depends on the control of the transistors of the rectifier 3, which in return determines the currents received from the phases of the three-phase network 2. The neutral-point direct current Idc is then used to generate a magnetic field about the windings 9, 10, 11 of the electric traction unit.

The output of the rectifier 3 also results in the establishment of a voltage Vd between the connection 7 and the connection 8. The connection 8 is then brought to a negative high voltage HV−.

Furthermore, the phases of the inverter 15 enable generation of the power supply voltages of the windings 9, 10, 11 of the electric traction unit.

The battery is recharged when the vehicle is stopped. The control of the currents and voltages applied to the windings 9, 10, 11 is then such that no engine torque is generated. However, as explained above, all of these elements are in the structure of the circuit made when the charger is connected to the vehicle. Accordingly, these different elements contribute to recharging the battery.

The method for controlling the switches of the rectifier is intended to determine the opening and closing instants of the switches in order to obtain the desired three-phase current (Iph1, Iph2, Iph3) and the desired neutral-point current. The following control method is based on the assumption that the sum of the currents on each phase is zero (Iph1+Iph2+Iph3=0), and that the currents of each phase are out of phase by 2π/3.

Each combination of positions of each of the six switches 20, 27, 34, 22, 29, 36 of the rectifier make it possible to obtain a known neutral-point current as well as a remarkable current vector (V1, V2, V3, V4, V5, V6) in the Fresnel space. The switch combinations, the related remarkable vectors and the currents on each phase are shown in table 1 and the correspondence thereof in the Fresnel space in FIG. 2. By combining several remarkable current vectors (V1, V2, V3, V4, V5, V6), it is possible to obtain all of the current vectors in the Fresnel space. Indeed, a current vector is obtained by determining the weighted vector sum of the two current vectors surrounding the sector in which the current vector to be determined is found. The weighting coefficients are then transposed into durations during which each of the vectors is applied. The average durations weighted by the intensity corresponding to the vector make it possible to obtain the neutral-point current outputted by the rectifier. However, application of the current vectors only represents part of the duration of application of a neutral-point current vector, otherwise referred to as a switching period. The neutral-point current vector is specifically the vector resulting from the vector sum of the current vectors applied. The remaining duration is completed by application of a freewheeling vector, generating a zero neutral-point current. Table 1 includes the three switch combinations leading to a freewheeling vector (V01, V02, V03). Switch 1H corresponds to transistor 22, switch 2H corresponds to transistor 29, switch 3H corresponds to transistor 36, switch 1L corresponds to transistor 20, switch 2L corresponds to transistor 27 and switch 3L corresponds to transistor 34.

TABLE 1

| Closed | Current | Current | Current | Current |
|---|---|---|---|---|
| switches | Iph1 | Iph2 | Iph3 | vectors |
| 1H-2L | Idc | −Idc | 0 | V1 |
| 1H-3L | Idc | 0 | −Idc | V2 |
| 2H-1L | −Idc | Idc | 0 | V3 |
| 2H-3L | 0 | Idc | −Idc | V4 |
| 3H-1L | −Idc | 0 | Idc | V5 |
| 3H-2L | 0 | −Idc | Idc | V6 |
| 1H-1L | 0 | 0 | 0 | V01 |
| 2H-2L | 0 | 0 | 0 | V02 |
| 3H-3L | 0 | 0 | 0 | V03 |

Application of a freewheeling vector makes it possible to supplement the application duration of a vector, which makes it possible to obtain switching periods of equal length, regardless of the application times of the remarkable current vectors. Furthermore, since the neutral-point current associated with these freewheeling vectors is zero, the result of application of the remarkable current vectors is not modified in terms of the neutral-point current.

Also in terms of the neutral-point current, it is unimportant which of the freewheeling vectors is applied, and the order of application of the different vectors during the switching period is also unimportant. Only the application durations and the coordinates of the current vectors in the Fresnel space matter.

However, in terms of the negative high voltage, application of one or other of the freewheeling vectors results in application of a different potential on the conductor 8, and therefore a variation in the negative high voltage. These variations are significant both in amplitude and in frequency. Indeed, the value of the negative high voltage is determined as a function of which of the switches 20, 27 and 34 is actuated. If switch 20 is actuated, the potential Vph1 is applied. If switch 27 is actuated, the potential Vph2 is applied. If switch 34 is actuated, the potential Vph3 is applied. The switch combinations enabling the different vectors to be obtained therefore involve switches 20, 27 and 34.

Table 2 shows a method for controlling a rectifier according to the prior art.

TABLE 2

| | Current | Freewheeling |
|---|---|---|
| Sector | vectors | vector |
| 1 | V1, V2 | V01 |
| 2 | V4, V2 | V03 |
| 3 | V4, V3 | V02 |
| 4 | V5, V3 | V01 |
| 5 | V5, V6 | V03 |
| 6 | V1, V6 | V02 |

It can be seen that the freewheeling vector changes with each sector change. Relating these freewheeling-vector changes, the potential deviations explained above, and the negative high-voltage potentials associated with the combinations leading to the remarkable current vectors helps to explain how sudden variations in the negative high-voltage value could occur. These variations result in the appearance of significant leakage currents.

During a switching period, each switch combination can potentially result in a different negative high-voltage potential. In the worst case scenario, a switching period may result in application of a first potential during application of a remarkable current vector, application of a second potential during application of another remarkable current vector, then application of a third potential during application of a freewheeling vector.

A voltage deviation appears in particular if the freewheeling vector applied leads to a negative high voltage different to the one resulting from the previous application of a remarkable or freewheeling current vector.

In order to limit these variations, the control method according to the invention checks the freewheeling vector applied as a function of the current vectors applied. To minimize the negative high-voltage deviations, the sectors shown in FIG. 2 are divided in two. This creates 12 sectors marked 1a to 6b, as shown in FIG. 3. There are several possible control methods, as shown in tables 2 to 9.

A first control method selects, for each combination of two given vectors, a freewheeling vector that has a minimum negative high-voltage deviation in relation to the negative high voltage generated by the remarkable current vector having the greatest contribution to the neutral-point current. This control method is shown in table 3.

TABLE 3

| | Current | Freewheeling |
|---|---|---|
| Sector | vectors | vector |
| 1a | V1, V2 | V02 |
| 1b | V1, V2 | V03 |
| 2a | V4, V2 | V03 |
| 2b | V4, V2 | V03 |
| 3a | V3, V4 | V03 |
| 3b | V3, V4 | V01 |
| 4a | V5, V3 | V01 |
| 4b | V5, V3 | V01 |
| 5a | V5, V6 | V01 |
| 5b | V5, V6 | V02 |
| 6a | V1, V6 | V02 |
| 6b | V1, V6 | V02 |

A second control method selects a freewheeling vector that varies within a single sector, but that has a deviation from the negative high voltage generated by the application of the remarkable current vectors that corresponds at most to the voltage deviation between two phases. Although less efficient than the first control method, the second control method nonetheless has an advantage in relation to the control method in the prior art. This control method is shown in table 4.

TABLE 4

| | Current | Freewheeling |
|---|---|---|
| Sector | vectors | vector |
| 1a | V1, V2 | V03 |
| 1b | V1, V2 | V02 |
| 2a | V4, V2 | V02 |
| 2b | V4, V2 | V01 |
| 3a | V3, V4 | V01 |
| 3b | V3, V4 | V03 |
| 4a | V5, V3 | V03 |
| 4b | V5, V3 | V02 |
| 5a | V5, V6 | V02 |
| 5b | V5, V6 | V01 |
| 6a | V1, V6 | V01 |
| 6b | V1, V6 | V03 |

A third control method applies a freewheeling vector to four consecutive half-sectors. The first freewheeling vector V01 is applied from sectors 6b to 2a, the second vector V02 is applied from sectors 2b to 4a, the third vector V03 being applied from sectors 4b to 6a. The third control method is shown in table 5.

TABLE 5

| | Current | Freewheeling |
|---|---|---|
| Sector | vectors | vector |
| 1a | V1, V2 | V01 |
| 1b | V1, V2 | V01 |
| 2a | V4, V2 | V01 |
| 2b | V4, V2 | V02 |
| 3a | V3, V4 | V02 |
| 3b | V3, V4 | V02 |
| 4a | V5, V3 | V02 |
| 4b | V5, V3 | V03 |
| 5a | V5, V6 | V03 |
| 5b | V5, V6 | V03 |
| 6a | V1, V6 | V03 |
| 6b | V1, V6 | V01 |

A fourth control method applies the first freewheeling vector V01 to all of the half-sectors. The fifth and sixth control methods apply respectively the second freewheeling vector V02 and the third freewheeling vector V03 to all of the half-sectors. The fourth, fifth and sixth methods are shown respectively by tables 6, 7 and 8.

TABLE 6

| | Current | Freewheeling |
|---|---|---|
| Sector | vectors | vector |
| 1a | V1, V2 | V01 |
| 1b | V1, V2 | V01 |
| 2a | V4, V2 | V01 |
| 2b | V4, V2 | V01 |
| 3a | V3, V4 | V01 |
| 3b | V3, V4 | V01 |
| 4a | V5, V3 | V01 |
| 4b | V5, V3 | V01 |
| 5a | V5, V6 | V01 |
| 5b | V5, V6 | V01 |
| 6a | V1, V6 | V01 |
| 6b | V1, V6 | V01 |

TABLE 7

| | Current | Freewheeling |
|---|---|---|
| Sector | vectors | vector |
| 1a | V1, V2 | V02 |
| 1b | V1, V2 | V02 |
| 2a | V4, V2 | V02 |
| 2b | V4, V2 | V02 |
| 3a | V3, V4 | V02 |
| 3b | V3, V4 | V02 |
| 4a | V5, V3 | V02 |
| 4b | V5, V3 | V02 |
| 5a | V5, V6 | V02 |
| 5b | V5, V6 | V02 |
| 6a | V1, V6 | V02 |
| 6b | V1, V6 | V02 |

TABLE 8

| | Current | Freewheeling |
|---|---|---|
| Sector | vectors | vector |
| 1a | V1, V2 | V03 |
| 1b | V1, V2 | V03 |
| 2a | V4, V2 | V03 |
| 2b | V4, V2 | V03 |
| 3a | V3, V4 | V03 |
| 3b | V3, V4 | V03 |
| 4a | V5, V3 | V03 |
| 4b | V5, V3 | V03 |
| 5a | V5, V6 | V03 |
| 5b | V5, V6 | V03 |
| 6a | V1, V6 | V03 |
| 6b | V1, V6 | V03 |

A seventh control method is a variant of the first control method. It differs therefrom in the phase difference of the freewheeling vectors applied to each half-sector. The vector applied in the half-sector 1a according to the seventh control method corresponds to the vector applied in the half-sector 6b of the first control method. The freewheeling vectors applied in the other half-sectors are offset such that the succession of vectors applied by the first control method is conserved. This control method is shown in table 9.

TABLE 9

| | Current | Freewheeling |
|---|---|---|
| Sector | vectors | vector |
| 1a | V1, V2 | V02 |
| 1b | V1, V2 | V02 |
| 2a | V4, V2 | V03 |
| 2b | V4, V2 | V03 |
| 3a | V3, V4 | V03 |
| 3b | V3, V4 | V03 |
| 4a | V5, V3 | V01 |
| 4b | V5, V3 | V01 |
| 5a | V5, V6 | V01 |
| 5b | V5, V6 | V01 |
| 6a | V1, V6 | V02 |
| 6b | V1, V6 | V02 |

An eighth control method is a variant of the first control method. It differs therefrom in the phase difference of the freewheeling vectors applied to each half-sector. It differs therefrom in the phase difference of the freewheeling vectors applied to each half-sector. The vector applied in the half-sector 1a according to the seventh control method corresponds to the vector applied in the half-sector 1b of the first control method. The freewheeling vectors applied in the other half-sectors are offset such that the succession of vectors applied by the first control method is conserved. This control method is shown in table 10.

TABLE 10

| | Current | Freewheeling |
|---|---|---|
| Sector | vectors | vector |
| 1a | V1, V2 | V03 |
| 1b | V1, V2 | V03 |
| 2a | V4, V2 | V03 |
| 2b | V4, V2 | V03 |
| 3a | V3, V4 | V01 |
| 3b | V3, V4 | V01 |
| 4a | V5, V3 | V01 |
| 4b | V5, V3 | V01 |
| 5a | V5, V6 | V02 |
| 5b | V5, V6 | V02 |
| 6a | V1, V6 | V02 |
| 6b | V1, V6 | V02 |

1-5. (canceled)

6. A method for controlling switches of a current rectifier in a motor vehicle including an on-board charger that can be connected to a three-phase electricity distribution network, the method comprising:
determining a neutral-point current intensity required at an output of the rectifier;
determining coordinates of a current vector enabling the neutral-point current to be obtained in a Fresnel space comprising six sectors delimited by six remarkable vectors;
determining a half-sector comprising the current vector from twelve half-sectors forming the Fresnel space;
determining a weighted vector combination of two remarkable vectors delimiting the Fresnel sector enabling the current vector to be obtained;
determining an opening/closing sequence of the switches of the current rectifier as a function of weighting coefficients of the weighted vector combination of the remarkable vectors; and
determining an opening/closing sequence of the switches of the current rectifier to obtain a freewheeling vector for a remaining duration of the switching period minimizing voltage deviations between ground and the voltage rectifier when switching from one opening/closing sequence of the switches of the current rectifier to another.

7. The control method as claimed in claim 6, in which, for each opening/closing sequence of the switches of the current rectifier used to obtain a current vector, an opening/closing sequence of the switches of the current rectifier is determined to obtain a freewheeling vector that has a minimum voltage deviation between ground and the voltage rectifier when switching from the opening/closing sequence of the switches of the current rectifier used to obtain the current vector to the one used to obtain the freewheeling vector.

8. The control method as claimed in claim 6, in which, for each opening/closing sequence of the switches of the current rectifier used to obtain a current vector, an opening/closing sequence of the switches of the current rectifier is determined to obtain a freewheeling vector that has a voltage deviation between ground and the voltage rectifier when switching from the opening/closing sequence of the switches of the current rectifier used to obtain the current vector to the one used to obtain the freewheeling vector, the voltage deviation being at most equal to the voltage deviation between two phases.

9. The control method as claimed in claim 6, in which, for each opening/closing sequence of the switches of the current rectifier used to obtain a current vector, an opening/closing sequence of the switches of the current rectifier is determined to obtain a first freewheeling vector if the half-sector including the current vector is one of four consecutive half-sectors, a second freewheeling vector if the half-sector including the current vector is one of four other consecutive half-sectors, and a third freewheeling vector if the half-sector including the current vector is one of the four remaining consecutive half-sectors.

10. The control method as claimed in claim 6, in which a same opening/closing sequence of the switches of the current rectifier used to obtain a freewheeling vector is applied regardless of the opening/closing sequence of the switches of the current rectifier used to obtain a current vector.
